(19) United States
(12) Patent Application Publication
(10) Pub. No.: US 2006/0212906 A1
(43) Pub. Date: Sep. 21, 2006

(54) System and method for digital media navigation and recording

(76) Inventor: James C. Cantalini, New York, NY (US)

Correspondence Address: MORRISON & FOERSTER LLP, 1650 TYSONS BOULEVARD, SUITE 300, MCLEAN, VA, 22102, US

(21) Appl. No.: 11/363,286

(22) Filed: Feb. 28, 2006

Related U.S. Application Data
(60) Provisional application No. 60/662,813, filed on Mar. 18, 2005.

(51) Int. Cl. H04N 7/16

(52) U.S. Cl. 725/62

(57) ABSTRACT

Describe are systems and methods for receiving, navigating, selecting and viewing data (including personalized content recommendations generated by the UGuide Recommendation Engine, television program listings and program descriptions) on handheld wireless communication devices and/or internet browsers. The invention also provides the ability to remotely control the scheduling of recordings on digital recording devices through a variety of transfer mediums, including broadband or dial-up internet connectivity as well as cable and satellite television systems.

### REFERENCE TO RELATED APPLICATIONS

This application claims priority to U.S. Provisional Application No. 60/662,813, filed Mar. 18, 2005, the contents of which are hereby incorporated by reference.

### FIELD OF INVENTION

This invention relates to systems and methods for receiving, navigating, selecting and viewing data for remotely scheduling recordings on digital recording devices using handheld wireless devices.

### BACKGROUND

Digital recording devices, such as digital video recorders, have allowed viewers to schedule the recording of programs in advance and then view the program at any convenient time. Typically, the programming of these recorders occurs at the viewer's home in the presence of the recorder. Unfortunately, it is not always convenient to schedule the programming at home and, therefore a need exists for methods for remotely managing recording devices.

Currently, there are a few products that allow service subscribers to view TV listings on mobile devices and/or remotely manage and schedule recordings on their in-home DVRs, via a website interface. Examples of these systems are shown in U.S. patent application Ser. No. 09/872,491 to Istvan, et al and Ser. No. 09/828,663 to Susskind. These applications describe systems in which web enabled devices such as a personal computer are able to remotely configure a recording device.

However, there is currently no system that enables users to remotely manage and schedule recordings via a cellular network using an application on a wireless mobile device.

### SUMMARY

Described are systems and methods for receiving, navigating, selecting and viewing data (including personalized content recommendations generated by the UGuide Recommendation Engine, television program listings and program descriptions) on handheld wireless communication devices and/or internet browsers. The invention also provides the ability to remotely control the scheduling of recordings on digital recording devices through a variety of transfer mediums, including broadband or dial-up internet connectivity as well as cable and satellite television systems. The system includes: generation and import of recording requests, and the processing and delivery to various kinds of recording devices through multiple transport mechanisms.

The method incorporates applications, protocols, databases and data formats for interactive digital television (iTV) with special focus on DVRs, PCs and Gaming Consoles for recording of selected events such as TV programs, shows, advertisements, pictures etc.

One embodiment of the system for scheduling recordings on a handheld wireless device includes a handheld wireless device with an application configured to allow selection of program content to be recorded on a recording device, a server system configured to receive instructions for recording a program from a handheld wireless device and configured to transmit instructions to a recording device, and a recording device configured to receive instructions from the server system and configured to record program content selected on the handheld wireless device.

Preferably, the program content is broadcast television content, broadcast radio content, satellite radio content or satellite television content. The program content may also be content transmitted on the Internet. Preferably, the program content is in digital format.

Preferably, the server transmits TV listing data to the handheld device. Preferably, the server transmits a list of recommended program content to the handheld device at specified intervals and a third-party provider is able to transmit selections to the server for the list of recommended program content. Preferably, the list of recommended program content is selected based on preference criteria that are specific to a user of the handheld wireless device.

Preferably, the recording device is a digital recording device, such as a digital video recorder. The recording device can receive instructions from the server over the Internet or over a broadcast stream. The broadcast stream may be, for example, a program stream of a cable or satellite or cable television system. Preferably, the recording device has a unique Device ID and the server identifies the recording device utilizing the Device ID.

Preferably, the recording device transmits messages to the server. The messages may include, for example, recording conflict alerts or scheduling conformations. Preferably, the server transmits the messages to the handheld wireless device.

An embodiment of the method of scheduling recordings on a handheld wireless device may include receiving instructions from a handheld wireless device over a cellular network, and transmitting instructions to a recording device to record program content based on the instructions from the handheld wireless device.

An embodiment of a handheld wireless device configured to schedule recordings on a recording device may include a handheld wireless device including an application configured to allow selection of program content to be recorded on a recording device.

### BRIEF DESCRIPTION OF THE DRAWINGS

FIG. 1 is a flow diagram showing the components of one embodiment of the UGuide system.

FIG. 2 is a diagram of the user interface Welcome screen with Login and Register options.

FIG. 3 is a diagram of the user interface Login screen prompting a user to enter their username.

FIG. 4 is a diagram of the user interface Login screen showing an Error message and prompting the user to enter a different ID.

FIG. 5 is a diagram of the user interface Home screen providing users with introductory, top-level navigation.

FIG. 6 is a diagram of the user interface Registration screen with introductory comments.

FIG. 7 is a diagram of the user interface Registration screen with a prompt to create a unique username.

FIG. 8 is a diagram of the user interface Registration screen with an Error message that the selected user name already exists.

FIG. 9 is a diagram of the user interface Registration screen with an alert that if the user goes Back none of the user information will be saved.

FIG. 10 is a diagram of the user interface prompting the user to enter their zip code.

FIG. 11 is a diagram of the user interface Error screen notifying the user that the zip code was not found.

FIG. 12 is a diagram of the user interface prompting the user to specify the type of television service received.

FIG. 13 is a diagram of the user interface prompting the user to select a television service provider.

FIG. 14s a diagram of the user interface prompting the user to select a channel lineup.

FIG. 15 is a diagram of the user interface prompting the user to select a channel subscription level.

FIG. 16 is a diagram of the user interface offering the user to include pay-per-view channels in the channel list.

FIG. 17 is a diagram of the user interface requesting the user's DVR ID to enable remote scheduling of a DVR device.

FIG. 18 is a diagram of the user interface congratulation screen notifying the user that their account has been activated.

FIG. 19 is a diagram of the user interface asking the user whether they would like to setup a personal profile.

FIG. 20 is a diagram of the user interface displaying a favorites list for broadcast channels.

FIG. 21 is a diagram of the user interface pop-up menu specify Update, All and None choices for the broadcast menu.

FIG. 22 is a diagram of the user interface with all of the broadcast channels selected.

FIG. 23 is a diagram of the user interface pop-up menu specify Update, All and None choices for the broadcast menu.

FIG. 24 is a diagram of the user interface displaying a favorites list for Basic service.

FIG. 25 is a diagram of the user interface pop-up menu specify Update, All and None choices for the Basic service menu.

FIG. 26 is a diagram of the user interface displaying a favorites list for Extended service.

FIG. 27 is a diagram of the user interface pop-up menu specify Update, All and None choices for the Extended service menu.

FIG. 28 is a diagram of the user interface displaying a favorites list for Premium service.

FIG. 29 is a diagram of the user interface pop-up menu specify Update, All and None choices for the Premium service menu.

FIG. 30 is a diagram of the user interface asking the user whether they would like to include pay-per-view programming in their favorites list.

FIG. 31 is a diagram of the user interface informing the user that the selected favorite channel information has been stored.

FIG. 32 is a diagram of the user interface Profile set up screen, which presents the user with a scrollable, selectable list of titles, including movies, episodic TV series and other programs.

FIG. 33 is a diagram of the user interface Profile set up screen with chosen shows selected.

FIG. 34 is a diagram of the user interface confirming that the Profile information has been submitted and saved.

FIG. 35 is a diagram of the user interface providing the user with the day's recommended programming.

FIG. 36 is a diagram of the user interface pop-up menu in which a user can select Info in order to see a desired Program Description.

FIG. 37 is a diagram of the user interface with a scrollable list showing Today plus the next six days.

FIG. 38 is a diagram of the user interface with a scrollable list of a 24 hour time period, displayed in 1 hour increments.

FIG. 39 is a diagram of the user interface listing the channels available in the user's favorite channel lineup.

FIG. 40 is a diagram of the user interface pop-up navigational menu, which allows a user to select View All Channels.

FIG. 41 is a diagram of the user interface listing all channels available to the user.

FIG. 42 is a diagram of the user interface Program screen displaying a scrollable list of program titles.

FIG. 43 is a diagram of the user interface showing a pop-up menu containing the Info option in addition to View All Channels, View Favorite Channels and the core navigation options.

FIG. 44 is a diagram of the user interface TV Grid, which presents a scrollable listing of channels and scheduled programs.

FIG. 45 is a diagram of the user interface TV Grid with “Smallville” selected and related information displayed in the mini-program description area.

FIG. 46 is a diagram of the user interface showing a pop-up menu containing the Info option in addition to View All Channels, View Favorite Channels and the core navigation options.

FIG. 47 is a diagram of the user interface showing a detailed program description.

FIG. 48 is a diagram of the user interface navigation screen that includes No Action; Record; Remind; and Add to Favorites options.

FIG. 49 is a diagram of the user interface program detail screen with the Record option selected.

FIG. 50 is a diagram of the user interface Confirmation screen informing the user that the Record Request for the desired program has been sent.

FIG. 51 is a diagram of the user interface pop-up menu providing the user with the core navigation.

FIG. 52 is a diagram of the user interface Settings screen that presents the user with a menu of selectable items reflecting the information provided by the user during the Registration process.

FIG. 53 is a diagram of the user interface zip code screen with a text entry field.

FIG. 54 is a diagram of the user interface Register screen alerting the user that if they go back the information they entered will not be saved.

FIG. 55 is a diagram of the user interface Error screen notifying the user that the zip code was not found.

FIG. 56 is a diagram of the user interface Edit TV Service screen.

FIG. 57 is a diagram of the user interface Edit TV Provider screen.

FIG. 58 is a diagram of the user interface Edit Channel Lineup screen.

FIG. 59 is a diagram of the user interface Edit Channel Lineup Levels screen.

FIG. 60 is a diagram of the user interface Edit Pay-Per-View screen.

FIG. 61 is a diagram of the user interface Edit DVR ID screen.

FIG. 62 is a diagram of the user interface Edit Profile screen with a list of show titles.

FIG. 63 is a diagram of the user Select Channels for Broadcast TV screen.

FIG. 64 is a diagram of the user interface pop-menu with Update, All and None selections.

FIG. 65 is a diagram of the user interface channel selection screen for Basic service.

FIG. 66 is a diagram of the user interface pop-menu with Update, All and None selections.

FIG. 67 is a diagram of the user interface edit Extended Channels screen.

FIG. 68 is a diagram of the user interface edit Premium Channels screen.

FIG. 69 is a diagram of the user interface edit Pay-Per-View Channels screen.

FIG. 70 is a diagram of the user interface About UGuide screen, which provides basic information about the UGuide application.

### DETAILED DESCRIPTION

The invention enables the use of mobile phones or other handheld wireless devices to receive, view and navigate data, including digital recording device program guides and personalized content recommendations. The invention also enables users to remotely control the scheduling of recordings on digital recording devices, for example DVRs. The digital recording device application that allows users to perform these tasks on their handheld wireless devices is referred to as the “UGuide” herein. The recording of programming utilizing the UGuide is preferably deployed as a resident application on a cell phone or other wireless device. Alternatively, or in addition, the UGuide can include a website-based service.

As used herein, “mobile device” refers to cell phones, PDA's and any other handheld mobile devices that are capable of running third-party applications and transmitting/receiving data via private or public wireless networks. Preferably, such mobile devices are not dependent upon internet access points but upon cellular networks, which provide a much wider and more reliable method of connectivity. (For example, if you were to connect to the internet using internet access points, you would most likely not be able to maintain a continuous internet connection if you got into your car and drove across town; you would quickly leave the area covered by the internet access point and may or may not be able to detect and use someone else's as you drove past. In contrast cellular networks are much more likely to maintain connections.) Thus, the UGuide enables users to schedule recordings from a much greater number of more remote locations.

Since the UGuide application preferably operates off of a cellular interface, a mobile device running the UGuide would allow a user to send and receive data without the need for a WAP interface. WAP requires a browser to access and display a server-side application, and the performance is sub-optimal. In comparison, the UGuide application can reside on a mobile device, allowing for much faster performance.

In one embodiment a user would download a client-server UGuide application, for example via the internet, from a server onto a wireless mobile device (e.g., a cell phone). Once the application has been downloaded, the user can register with the UGuide service and activate a personal account. All account information can then be stored on a secure server. The application would remain resident on the mobile device. Alternatively, or in addition, users could register via the UGuide website and use the web-based version of the application.

The invention permits any registered user to personalize the service, creating an individual profile containing the user's preferences for a variety of content, such as digital radio programming, TV series, movies, genres, etc. These profile inputs, in conjunction with collaborative filtering technology and other types of recommendation-generation techniques, are used by the UGuide's recommendation engine to compare the user's content preferences with current radio and television listings data, identifying those programs that most closely match the user's listening and viewing tastes. The recommendation engine (or alternatively, third-party recommendation providers) can then generate personalized programming suggestions, delivered to the user via the UGuide application, using a communication network such as the Internet.

To record a program (including a recommended program), the user can select the “Record” option associated with a specific program description. Alternatively, the user can manually enter a day/date, time, channel and duration of a desired program recording. In either scenario, the application resident on the handheld device can create a request to schedule the desired recording. Once generated, the recording request can then be sent to the UGuide server via a communication network and stored in a database.

To more efficiently execute the instructions for recording programming, the method of remotely scheduling digital recording device recordings is preferably accomplished by having the controlling functionalities and features, including communication interfaces, resident on UGuide servers, which are in communication with the handheld devices and recording devices. According to this embodiment, only small enabling components and applications would be implemented in the handheld devices and digital recording devices.

UGuide enabled digital recording devices could be able to retrieve recording instructions, for example, via backchannel IP, via a one-way satellite, cable or terrestrial DTV network.

In another embodiment of the invention, a protocol enables a client application on the user's digital recording device to connect to the UGuide server via the Internet at scheduled intervals. The request from the client on the digital recording device to the server is preferably triggered based on a request frequency value. This frequency value can be a specified time interval, for example in minutes. Preferably, it is customizable within pre-set limits.

Preferably, the client will present its unique Device ID to the UGuide server and query the server for messages, retrieving any new recording requests that have been created and sent to the server by the user. Upon retrieval of a request, the scheduling component of the digital recording device can translate the request into a record instruction and add the desired program to the list of scheduled recordings stored on the user's digital recording device. If any previously-scheduled recordings conflict with the new recording, the protocol preferably enables the digital recording device client to communicate conflicts to the user by sending alerts to the UGuide mobile application via the backchannel IP. The user can then have the option and ability to resolve the conflict by canceling either the new record request or previously scheduled record request(s). However the user chooses to resolve conflicts, any updated recording requests can be sent to the UGuide server via a communication network and stored in the database for retrieval by the digital recording device.

In another embodiment of the invention, the UGuide Record Request Server is enabled with ‘broadcast’ capabilities, delivering program recording requests to the digital recording device via a privately or publicly owned network. Record requests, generated by the UGuide, can be embedded in a digital television signal (MPEG-2 transport stream.)

In the broadcast implementation, the UGuide server can use the digital TV transport stream to constantly broadcast all record requests to all users within the broadcast network. Each individual request is targeted to a specific digital recording device's Device ID. On the client-side, each digital recording device receiving the broadcast stream constantly “listens” for its package, which is marked with the digital recording device's unique Device ID. The device will “listen” when the tuner is not used. Upon receipt of a data package, the scheduling component of the digital recording device can translate the requests into record instructions and add the desired programs to the list of scheduled recordings stored on the digital recording device.

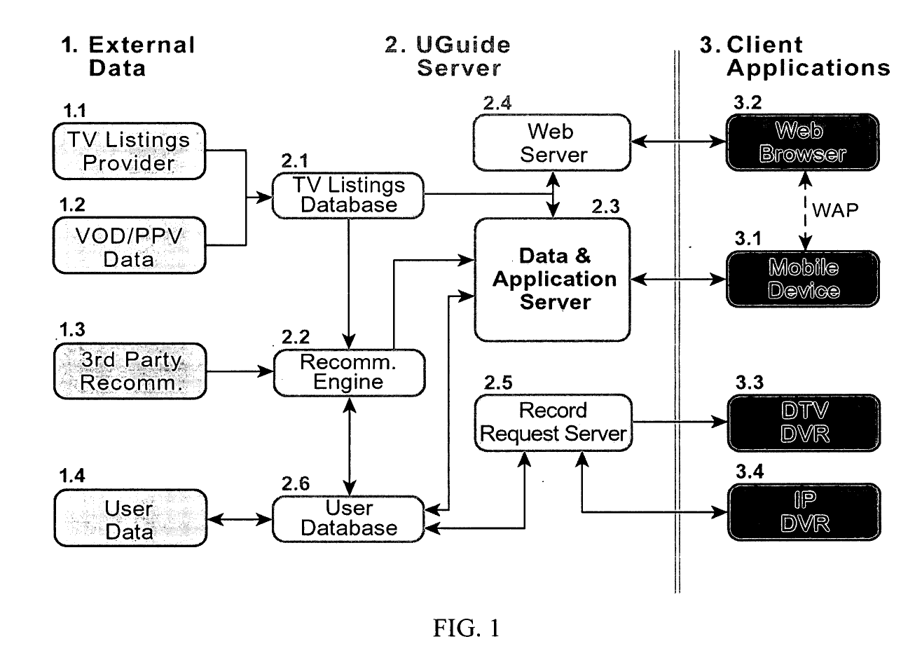

Embodiments of the components of the system are illustrated in FIG. 1. A detailed description of each component listed in FIG. 1, and an explanation of how data flows between the components, is included below. The method of connectivity and interaction between the components, as described, enables the functionality of the invention.

1. External Data Sources

2. TV Listings Provider

The richness of the application features (for example search functions for genres, etc.) is dependent upon the quality of the integrated TV listings data. In the United States, TRIBUNE MEDIA (TMS) is an example of a TV listings data provider. The UGuide imports data from the Listings Provider into the TV Listings Database (2.1).

1. VOD/PPV Data

In the case of Video-On-Demand and Pay-Per-View systems or other operator-specific offerings, the UGuide can import listings data from these external sources into the TV Listings Database (2.1).

1. Third-party Recommendations

Third-parties, such as operators or magazines, can provide editorial recommendations, which can be imported by the UGuide Recommendation Engine (2.2).

1. User Data

The UGuide preferably allows for the end consumer to create and edit his/her own personal profile. User-supplied data and/or other inputs are stored in the User Database (2.6).

2. UGuide Server

The UGuide server can run on standard open-source software platforms, which are supported by leading hosting operations. Server code and production processes can be written, for example, using JAVA, PYTHON, APACHE TOMCAT, JAVA servlets and MYSQL databases which can run on the LINUX operating system.

The UGuide server software can run on a general purpose, programmed digital computing device which includes a central processing unit (CPU), random access memory (RAM), non-volatile secondary storage device such as a hard drive, one or more network interfaces, and optionally a keyboard and monitor display. Program code, including software programs, and data can be loaded into the RAM for execution and processing by the CPU and results generated for display, output, transmittal, or storage. A specific example of suitable computer server hardware would be a DELL(R) POWEREDGE(R) 1850 server, with dual INTEL(R) XEON(R) 3.0 GHz processors, 2 GB RAM, and a 73 GB hard drive, and on-board NICs (Network Interface Cards).

2.1 TV Listings Database

The TV Listings database preferably stores all the TV listings data associated with a given data provider (1.1). The method of the invention uses the data schema supplied by the data provider and, as described above, relies on the object oriented capabilities of the system architecture to provide access to data provider-specific data attributes. As such, it is likely that there will be multiple listings databases corresponding to relationships with data providers in multiple countries/regions.

2.2 Recommendation Engine

The Recommendation Engine (RE) is capable of generating relevant and unique user recommendations based on a user's profile. Recommendations are generated using optimized algorithms capable of identifying recommendations based on:
explicit user choices (a user says s/he likes actor ‘A’ or director ‘B’)
implicit user choices (program attributes are harvested from a user's record history)
collaborative filtering-based recommendations
third-party recommendations (1.3)

The set of algorithms used can be customized for a given client, and can be delivered via a web-based EPG, mobile phone, or directly to a user's set top box.

2.3 Data & Application Server

The Data & Application Server provides a framework whereby UGuide services can be added and made available to clients. The services are used by web servers, web services, UGuide clients, and third parties. These services carry the business logic and provide the interface to components such as the TV listings database (2.1), user database (2.6), recommendation engine (2.2), and recording scheduler. A mobile UGuide client application (3.1), such as the J2ME MIDlet, connects to the Data & Application Server using TCP/IP. It will authenticate, may transmit user preferences, and load and display TV listings data or recommendations. Depending upon the request, the server in turn will update the user database (2.6), request listings from the TV listings database (2.1) or recommendations from the recommendation engine (2.2). A digital recording device will use the UGuide protocol to communicate with the server to identify itself, request record instructions, and if possible update the status of record instructions.

The server architecture allows the implementation of customizable user interfaces such as an HTTP or WAP server or the integration with SMS or other wireless services. All can use the same underlying services made available by the Data & Application server and can carry the same user from a mobile device to a web browser to a digital recording device.

2.4 Web Server

The web server is built around APACHE, APACHE TOMCAT, servlets and JSP. The web user interface display (HTML, CSS, etc.) has been separated from the application server code, so that web interfaces can be quickly customized. This allows the system to support, when necessary, a variety of web clients including standard web browsers and browsers optimized for mobile devices. Commercial branding and functional customization is also facilitated.

2.5 Record Request Server

The ‘Record Request’ Server (RRS) is responsible for satisfying requests for ‘record instructions’. A client process/program requests the record instructions for a given time period, and the RRS returns said record instructions. The record instructions contain the information required by the digital recording device to schedule a recording (channel, date, time, duration, etc.) along with any additional information that is needed to support features/functionality required by the customer. For instance, a password to ensure that only users with proper access can remotely program a digital recording device or additional data along with each record instruction to help the digital recording device perform conflict resolution-i.e. record instruction ‘priority’.

2.6 User Database

The user database stores all the user data requiring access, subject to the specifics of a given business relationship.

It is possible that the user data is stored in another company's database (1.4) and the UGuide system will only have access to the subset needed to perform the requisite tasks for said company.

3. Client Applications

Users can utilize the UGuide from an array of mobile devices in order to program their digital recording devices. The UGuide platform provides the following client-side components:

3.1 Mobile Device Application

The UGuide mobile client application is written in J2ME, so it can run on a variety of JAVA ME KVM enabled MIDP devices supporting of CLDC 1.0 and MIDP 1.0 or higher. Application JAR size is preferably kept low at about 64K, so it can work on a wide array of devices which support a KVM. The UGuide mobile client can also be implemented for native PALM, BREW, or WINDOWS CE platforms. Since other platforms like BREW and WINDOWS CE support internet protocols, no changes are necessary to the UGuide server architecture to enable network data access. The client can be flexible in the quantity of data fetched from the server and cached, depending upon the channels selected and device memory, with typical usage of 40K of data fetched. All server-side functionality has been separated from presentation. The UGuide mobile client communicates using TCP/IP to the server. Additionally, if a very narrow, precise functionality is desired then SMS (text messaging) can be initiated from the mobile device to send record or search instructions, i.e. “Record Program X at 8PM”.

The UGuide Mobile application offers robust functionality that helps users to navigate the vast amount of available digital content. The product feature set includes, but is not limited to:

User registration and login: Only registered subscribers will be able to use the service; users create their own ID's for login.

Personalization: Registered users are preferably able to set up profiles, specify favorite programs and favorite channels, and create personalized program guides.

Recommendations: Every day, the user can receive recommended programs that closely match the user's content preferences (e.g., preferred movies or TV programs.) Preferably, the recommendations would be limited to five or less.

Remote Digital Recording Device Recording: The user is able to create record requests for specific programs; these requests are stored on the UGuide server, where they are either broadcast to or retrieved by the user's digital recording device, which then schedules corresponding recordings.

TV List: A hierarchical, tiered-menu navigation that enables users to quickly “drill-down” to a specific program. Step 1: From a scrollable list displaying ‘Today’ plus the next 6 days, the user select a day (e.g., Wednesday); Step 2: From a scrollable list displaying a 24 hour time period, the user select a time (e.g., 8 PM); Step 3: User then selects a channel (e.g. 4 NBC); Step 4: The title of the appropriate program (e.g., the program airing on Channel 4 at 8 PM on Wednesday) is displayed. The user can select the title to see a full Program Description.

Full Program Description: Displays available program information, including start/end times, channel, genre, rating and synopsis; user options include Record Program and Add to Favorites.

Favorite Programs: An editable list of programs specified by the user as Favorites.

Scheduled Recordings List: A list of pending recordings that have been scheduled on the user's digital recording device via the UGuide.

Search: Keyword search for title, actor, director, or genre; results will include any programs in current listings that match Search criteria.

Reminders: The user will be able to schedule a reminder for a listed program and receive an alert before a desired program starts.

Impulse Recording: The user will be able to key in date, start time, duration and channel to create a record request whenever desired, without the need to view a specific program description.

3.2 Web Browser

The UGuide user interface can alternatively be served by a website. Should a local application on the mobile device (3.1) not be practical due to cost or operator issues, the mobile device can access a WAP site.

The web-based client application provides similar functionality to the mobile application, and can be offered as a complement.

3.3 DTV Digital Recording Devices

In a broadcast implementation, the Record Request Server (2.5) will use the digital TV transport stream to broadcast all record requests to all users within the broadcast network. Each individual request is targeted to a specific digital recording device's hardware device ID. On the client-side, each digital recording device receiving the broadcast stream constantly “listens” for its package, which is marked with the digital recording device's unique device ID. Upon receipt of a data package, the scheduling component of the digital recording device translates the requests into record instructions and adds the desired programs to the list of scheduled recordings stored on the user's digital recording device.

3.4 IP Digital Recording Devices

Digital recording devices and Media Center PCs that are enabled with ‘back channel’ IP capability are able to send as well as receive information. Messages (such as recording schedule conflicts) can be sent to the Record Request Server (2.5) by a digital recording device using the UGuide Record Protocol. To enable devices with this functionality, a digital recording device manufacturer or media-center software provider may implement only a client to the protocol. The protocol is designed to be flexible, allowing the digital recording device manufacturer to implement only as little or as much functionality as they are willing to. For instance, there are no software user interface requirements. The protocol supplements the existing digital recording device record software by allowing an additional input for record instructions. For a networked device, this means opening an IP connection, authenticating, and reading record instructions. In a broadcast environment, the device would have to read the instruction from the broadcast stream.

The following section provides an overview of how the invention might be used by an end user.

To use the invention, an individual would preferably first download the UGuide application to a cell phone or other wireless handheld device (such as a Palm Treo.) In the cell phone scenario, the user would connect to the internet and go to a URL where the application has been made available for download (e.g., http://www.uguide.tv/download.) Once the UGuide application has been downloaded and stored on the device, the user will be able to launch the application.

Specifics relating to navigation will differ from one mobile device to another, but the user should be able to locate the application via whatever menuing system is provided on the device. Typically, a top-level menu on a cell phone will contain numerous options, including one for Downloads. The UGuide would usually be located in a sub-section of Downloads that included available applications that have been downloaded and stored on the phone.

When the user launches the UGuide application, a graphical splash screen showing the UGuide logo is briefly displayed while the application loads.

Once the application is loaded, a Welcome screen is displayed. The user is prompted to Login or Register. If the user has previously set up and activated an account, she/he would enter the appropriate user name to login and use the application. New users would select Register and begin a multi-step process to set up a UGuide account.

The Registration process preferably requests the user to do the following:
Create a User Name
Provide the Zip code where TV service is received
Specify type of service (e.g., broadcast, cable or satellite)
Specify TV service provider (e.g., Time WARNER CABLE, DIRECTV)
Specify Channel levels received (e.g., Basic, Extended, Premium)
Specify whether or not the UGuide TV listings should include pay-per-view channels
Provide the unique hardware ID number of the user's digital recording device, if the user wants to scheduling recordings using the UGuide's remote recording features

In addition, users have the option to:
Set up Favorite Channels lists (e.g., Favorite Basic Channels, Favorite Premium Channels, etc.)
Set up a personalized Profile; to do so, the user would specify his/her individual content preferences by making selections from a list of sample movie and TV program titles. The user's content preferences are stored in the user database, and are used by the UGuide Recommendation engine in the process of generating appropriate, personalized program recommendations.

Other than the User Name, the information provided by the user can be changed by the user at any time.

After Login, the user can select from several options on the UGuide Home screen, linking to other screens and functionality that are part of the application. These options and features include, but are not limited to:
Recommended: Based on the user's individual Profile information, the UGuide Recommendation engine preferably generates a list of programs that closely match the user's content preferences. The programs listed are culled from the current TV listings data, and are scheduled to be broadcast within the next 24 hours on channels received by the user. The user can select any title on the recommended list to view a Program Description screen that provides more information about that individual program.
TV List: A tiered navigational system enables the user to quickly “drill down” to specific information for any program that is included in the current listings data. To do so, the user would first specify the Day for desired listings from a scrollable list (e.g., Today, Saturday, Sunday, etc.), then specify the Time (e.g., 1:00 PM, 2:00 PM, etc.), then a Channel (e.g., 105 USA or 106 TV LAND.) Once the user has chosen Day, Time and Channel, a Programs screen will display the title of the program that is scheduled for that specific slot (e.g., Sunday, 2:00 PM, USA: LAW & ORDER.) The Programs screen may also display one or more titles of programs that are scheduled in the time slot(s) immediately following the one selected (e.g., Sunday, 3:00 PM, USA: MONK.) The user can select any title listed to view a Program Description screen.
TV Grid: A standard-format electronic program guide (EPG) for viewing current, available TV listings data. The TV Grid displays a vertical listing of TV channels on the left of the screen and a horizontal listing of half-hour time slots across the top. To the right of each channel are listed the TV programs that are scheduled on that channel, in the appropriate time slot “box”. The TV Grid is scrollable on both the vertical and horizontal axes; more channels and program titles can be viewed by scrolling up or down, and more time slots can be viewed by scrolling right or left. When the user highlights a program title by using the navigational keys on the mobile device, a brief program description for the highlighted program appears at the bottom of the screen. The user can select any highlighted program title to view a Program Description screen. The user also has the option of viewing All Channels in the TV Grid or only Favorite Channels.
Settings: The Settings screen preferably enables the user to make changes to most of the account information provided during Registration. Using screens that are virtually identical in design and functionality to those in the Registration process, the user can change ZIP Code, Service Provider, Digital Recording Device ID, Profile, Favorite Channels, etc.
Previews: If promotional video clips are available, the user can select a title from a scrollable list (e.g., Coming Soon! movie titles) to download a clip for viewing on video-enabled mobile devices.
Search: The user can perform a keyword search for a program title, actor, director, or genre. Search results are displayed as scrollable lists and include any programs, actors, directors, etc. in the current listings that match the user's Search criteria.
Reminders: The user has the option of requesting a Reminder for any TV program in the listings data. To set up a reminder, the user selects Remind on the Program Description screen, and the information is stored on the UGuide server. The user will be alerted at a predetermined time (e.g., one hour before the program starts). Alerts can be delivered using a variety of mechanisms including email, SMS, messages retrieved by the application, etc.
Scheduled: The user can view a scrollable list of programs that have been scheduled for recording on the user's digital recording device.

To schedule a digital recording device recording remotely using the UGuide, the user selects any program title (on the TV List or TV Grid screens, or from the list of titles displayed on the Recommended screen) to view the full Program Description. In addition to details about the program (start and end times, channel, rating, synopsis, etc.) the Description screen offers users the option to Record the program. The user selects the Record option and clicks “Done” to create a Record Request for the chosen program. That Record Request is sent to the UGuide server and stored. At a predetermined interval, the user's digital recording device connects to the UGuide server via the Internet, communicates with the server using the UGuide Protocol, and checks for any new Record Requests; the digital recording device retrieves the user's Record Requests and generates corresponding record instructions, thus scheduling the desired recording(s.) When the recording has been scheduled, the digital recording device sends a confirmation to the user via email, SMS, messages retrieved by the application, etc.

In a typical scenario, a registered user could launch the UGuide application on his cell phone at 10 AM and Login. From the Home screen, this user would click on the Recommended link to view the day's UGuide recommendations. The Recommended programs match the user's viewing preferences, but one in particular grabs his attention so he clicks on the program title (PLANET OF THE APES) to get more details. This launches the Program Description, which gives a brief synopsis of the plot. The user sees that the movie is the 1968 original, not the awful remake, and that it is scheduled to air on AMC at 8 PM. He would like to watch it, but he won't get home until after 11 PM. So he clicks on the Record option to set up a recording on his digital recording device at home. He knows that in a few minutes he will be able to check and see if the recording was scheduled, so he links to the UGuide's TV List to see what's on his favorite channel, ESPN, at 11:30 PM. The user selects Today from the top-level TV List screen, then selects 11:00 P on the Time screen and 28 ESPN on the Channels screen. He sees that SPORTCENTER starts at 11, followed by NFL LIVE, so he knows he'll have something good to watch and unwind to after his long day. It's been a few minutes, so he clicks on the Menu and selects Scheduled. He sees that Planet of The Apes has been scheduled for recording, and is on the list right below SPONGEBOB SQUAREPANTS, which is scheduled to be recorded at 5 PM.

### EXAMPLES OF APPLICATION STORYBOARDS

Following are schematic representations of the UGuide user interface, navigation and process flow. These Examples are specific examples of how the UGuide interface may operate on a handheld device. The Examples and visuals presented should be considered as exemplary embodiments only as this invention is not intended to be limited to only these embodiments.

### Example 1

### Login

1. Welcome Screen

When the application is launched, a branded splash screen can briefly be displayed.

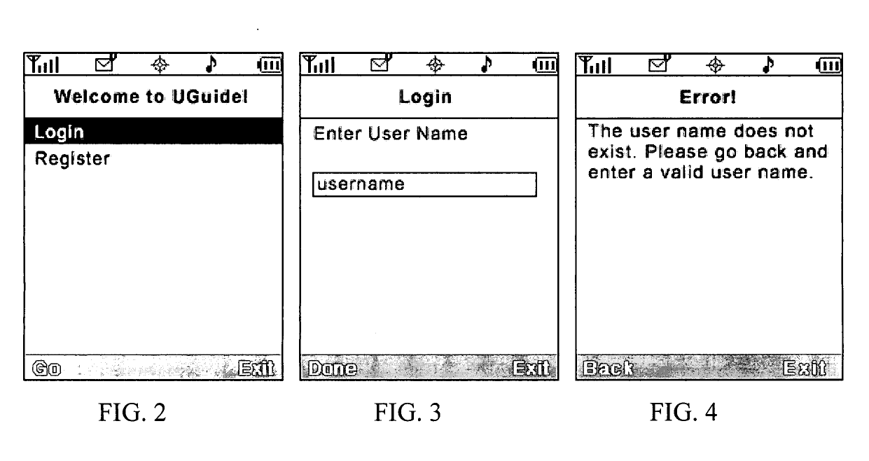

A Welcome screen can then be displayed. (See FIG. 2) User options include Login and Register. If desired, the user can quit the application at this point by selecting the Exit softkey or by pressing the End key on the mobile device keypad.

Registered subscribers, who have previously created a unique user ID, preferably are directed to use the ID to login and use the application. New users are preferably directed to select Register in order to set up an account. Users may highlight either option, then select the Go softkey or press OK on the mobile device keypad.

1. Login screen

The registered subscriber is prompted to enter the unique usemame associated with his/her individual account. (See FIG. 3). By default, login text entered during the most recent session is displayed in the entry field. The user can edit if desired. Softkey navigation is Done and Exit.

After entering the ID, the user selects the Done softkey. This initiates a validation process, during which the submitted ID is compared to existing ID's previously stored in the user database. While this validation is performed, a Please Wait message screen is displayed.

If the username does not match any of those that are stored in the database, an Error message is displayed, prompting the user to enter a different ID. (See FIG. 4). The Back softkey will return the user to the Login screen. Exit will quit the application.

If the username is valid, the user is logged in and the UGuide Home screen (1.3) will be displayed.

1. Home screen

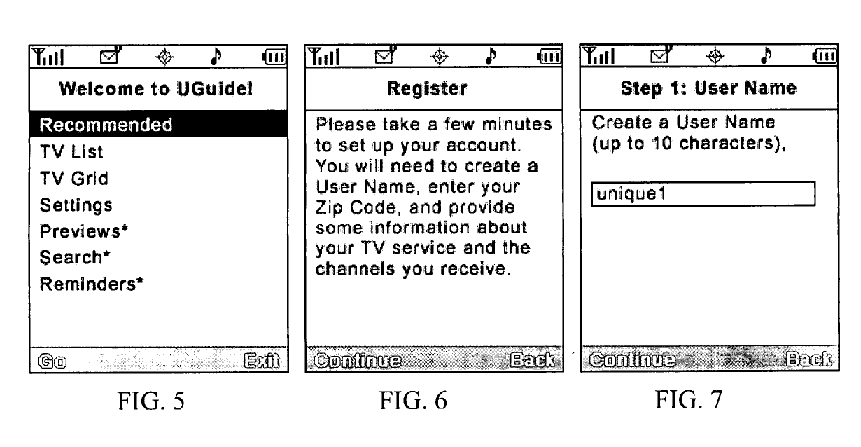

The Home screen provides users with introductory, top-level navigation. (See FIG. 5).

Softkey navigation options available to the user are Go and Exit. If the user highlights a menu choice and selects Go, the specified screen will load. Alternatively, the user could highlight a choice and click the OK button on the mobile device.

If the user selects the Exit softkey, the UGuide application will quit.

### Example 2

### Registration

2.1 Intro

Registration is preferably a multi-step process, presented in a ‘wizard’ format. The total number of steps can be dependent upon several variables. For the purposes of illustration, possible steps are included here.

The Registration process begins with an introductory screen. (See FIG. 6). The navigational options available to the user are Continue and Back. Continue initiates the multi-step Registration. Back returns the user to the Welcome screen (1.3.)

2.2 User Name

The user is prompted to create a unique username. (See FIG. 7). This name can be up to 10 characters long. The user enters the name into a text-entry field.

The options available to the user are Continue and Back. Continue initiates an ID validation process. The submitted ID is compared to the existing ID's in the user database. While this validation is performed, a Please Wait message screen is displayed.

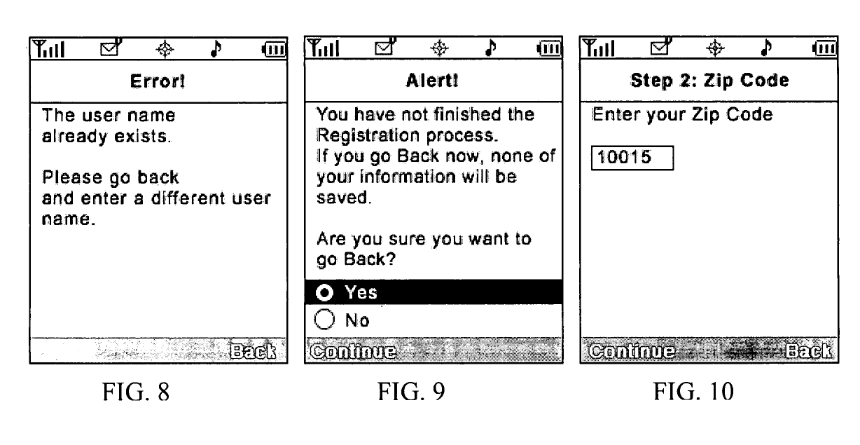

If the submitted usemame is unique, the Registration process advances to the Zip Code screen (2.3.) If the submitted user name already exists in the database, an Error message is displayed, prompting the user to go back and create a different user name. (See FIG. 8).

Yes brings the user to the introductory Registration screen (2.1); No brings the user back to the User Name screen, with the previously-entered user name displayed in the text entry field.

The Back key during the registration process will take to user to the introductory Registration screen (2.1.). If the user chooses to go Back from the User Name screen, none of the information entered thus far will be saved. This may hold true even if the user has proceeded through several of the additional Registration screens, and selected the Back button until returning the User Name screen. If the user is on the User Name screen and selects Back, an Alert prompt will appear. (See FIG. 9).

2.3 Zip Code

The user is prompted to enter the postal zip code for the location where television service is received. (See FIG. 10). The user enters the zip code into a text-entry field. This field preferably only accepts numbers and is limited to 5 digits.

On the Zip Code entry screen, the navigational options available to the user are Continue and Back. Back returns the user to the User Name screen (2.2.)

If the user enters 5-digit zip code and selects Continue, a zip code validation process is initiated. The submitted zip code is compared to zip codes in the database that are associated with television service providers across the United States. While this validation is performed, a Please Wait message screen can be displayed.

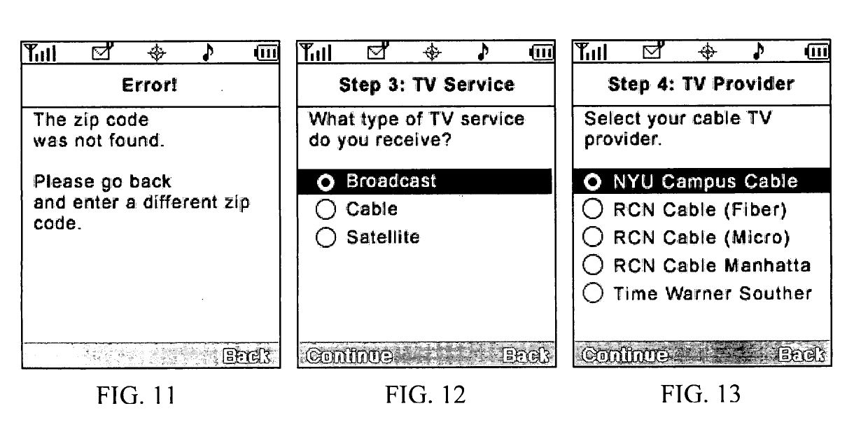

If the submitted zip code is valid, the Registration process advances to the next step (2.4 TV Service). If the zip code is invalid, an Error message is preferably displayed, prompting the user to go Back and enter a different zip code. (See FIG. 11).

2.4 TV Service

The user is prompted to specify the type of television service received. (See FIG. 12). The user can then choose one of the options.

Other than the TV service type selection, the softkey navigational options available to the user are Continue and Back. Back returns the user to the Zip Code screen (2.3).

If the user chooses Broadcast and then selects Continue, the Registration process advances directly to the digital recording device ID screen (2.9).

If the user chooses Cable or Satellite and then selects Continue, the Registration process advances to the TV Provider screen (2.5).

2.5 TV Provider

The user is prompted to select the appropriate cable or satellite TV service provider in the user's zip code. (See FIG. 13). Users preferably may choose only one provider.

Other than the service provider selections, the navigational options available to the user are Continue and Back. Back returns the user to the Type of Service screen (2.4).

If a satellite subscriber chooses a TV provider and then selects Continue, the Registration process advances directly to the Channel Levels screen (2.7).

If a cable subscriber chooses a TV provider and then selects Continue, the Registration process advances to the Channel Lineup screen (2.7).

2.6 Channel Lineup

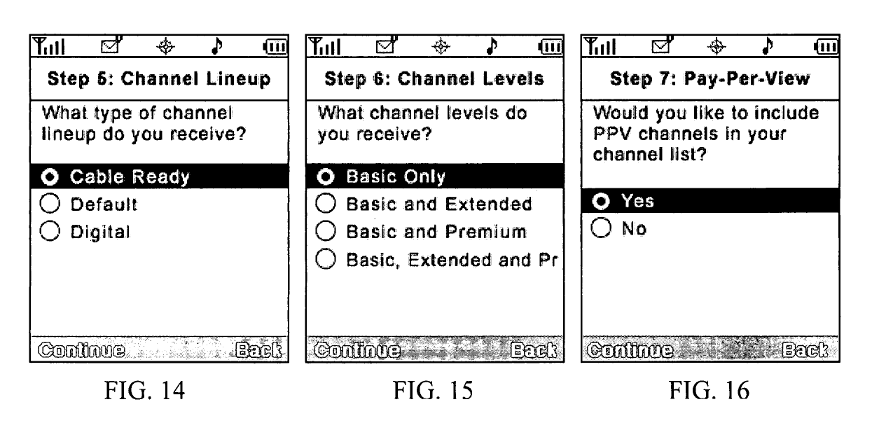

The user is prompted to specify the type of channel lineup received Choices presented to the user reflect the lineups offered by the TV service provider (see 2.5). (See FIG. 14).

Other than the Channel Lineup selections, the navigational options available to the user are Continue and Back. Back returns the user to the TV Provider screen (2.5).

If the user chooses a Channel Lineup and then selects Continue, the Registration process advances to the Channel Levels screen (2.7).

2.7 Channel Levels

The user is prompted to specify the Channel Levels received with the user's cable or satellite subscription. (See FIG. 15).

Other than the Channel Levels selections, the navigational options available to the user are Continue and Back. Back returns cable subscribers to the Channel Lineup screen (2.6) but returns satellite subscribers to the TV Provider screen (2.5).

If the user chooses a Channel Level and then selects Continue, the Registration process advances to the PPV Channels screen (2.8).

2.8 Pay-Per-View

The user is offered the option of including Pay-Per-View channels in the core Channel List. (See FIG. 16).

Other than Yes and No, the navigational options available to the user are Continue and Back. Back returns the user to the Channel Levels screen (2.7).

If the user chooses Yes and then selects Continue, the information will be saved and the Registration process advances to the Digital Recording Device ID screen (2.9). If the user chooses No and selects Continue, that information is stored and the process advances to the digital recording device ID screen.

While information is retrieved, a Please Wait message screen is displayed.

2.9 Digital Recording Device ID

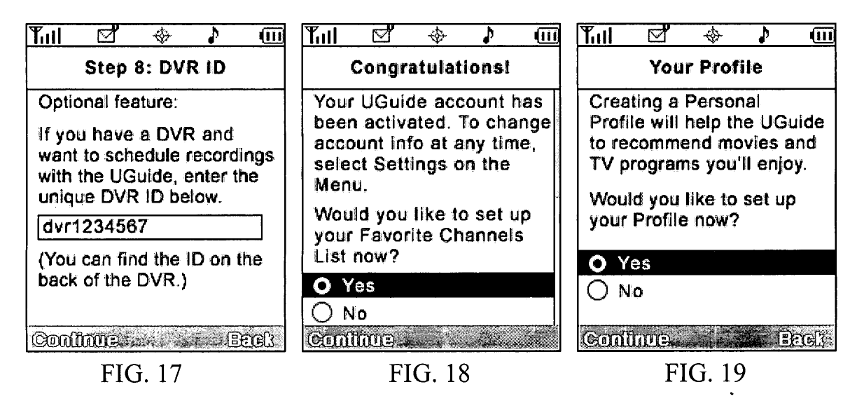

Remote scheduling of recordings on the user's digital recording device is an optional feature. Users who want to enable this feature are prompted to enter their digital recording device device's unique ID into a text field. (See FIG. 17).

Other than the text entry field, the navigational options available to the user are Continue and Back. Back returns the user to the PPV Channels screen (2.8).

The user is not required to enter any text in the Digital Recording Device ID field. Whether or not the user enters any text, if the user selects Continue, the Registration process advances to the Congratulations screen (2.10).

While the user's account information is sent and stored in the user database, a Please Wait message screen is displayed.

2.10 Congratulations Screen

Once all required information has been submitted and saved, a Congratulations screen displays a confirmation message. (See FIG. 18).

On the same screen, a second message prompts the user to move on to the optional steps in the Registration process (Favorite Channels.)

Other than Yes and No, preferably the only navigation option is Continue.

Cable and satellite users who choose Yes and select Continue will proceed to the Basic Channels list (2.15), the first in a series of Favorite Channels set-up screens.

Users with Broadcast service who choose Yes and select Continue will proceed to a Broadcast Channels list (2.12).

If the user chooses No and selects Continue, an interstitial screen will appear (2.11), prompting the user to set up a Personal Profile.

While information is retrieved, a Please Wait message screen is displayed.

2.11 Profile Interstitial Screen

The interstitial screen preferably only appears if the user chose not to set up a Favorite Channels list in the prior step (2.10.). (See FIG. 19).

Other than Yes and No, the navigational options available to the user are Continue and Back. Back returns the user to the Congratulations screen (2.10).

Users who choose Yes and select Continue will proceed to the Profile set-up screen (see Your Profile, 2.18.)

If the user chooses No and selects Continue, the UGuide Home screen (1.3) is displayed.

2.12 Favorites: Broadcast

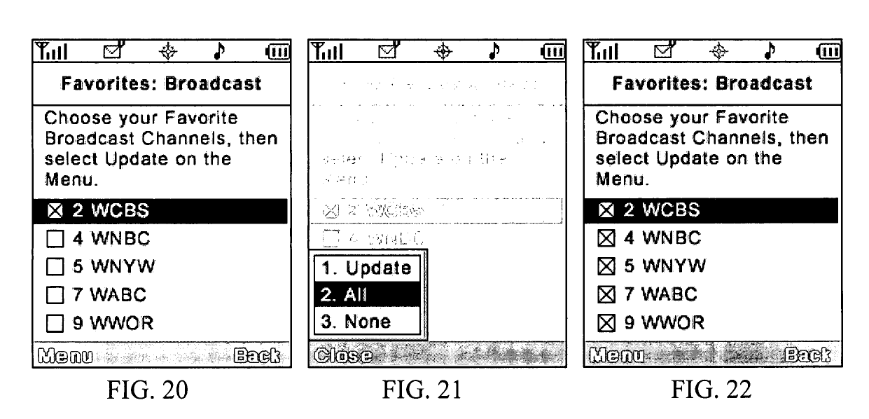

If a user has specified that s/he receives Broadcast channels, instead of Cable or Satellite service (see 2.4: Type of Service), preferably only one Favorites List screen will be displayed, because there is typically only one Broadcast channel level. (See FIG. 20).

On this screen, a scrollable list of the available Broadcast channels in the user's zip code is displayed. Each channel has a corresponding check box. By default, all channels are unselected.

The user is prompted to choose Favorite Broadcast Channels.

In addition, the navigational options provided are Menu and Back. Back returns the user to the Congratulations screen (2.10).

If the user selects Menu, a pop-up menu appears. On this pop-up, the user can highlight Update, All or None. If no action is desired, the pop-up menu can be closed and the list will remain unchanged. (See FIG. 21).

To specify all channels in the list as Favorites, the user would highlight All in the pop-up menu, then click OK on the device keypad. This will add a check mark next to every channel. (See FIG. 22). The user would select Menu again to open the pop-up menu, highlight Update and click OK on the keypad.

Clicking on the Close softkey will close the pop-up menu, without any changes being made to the list of channels.

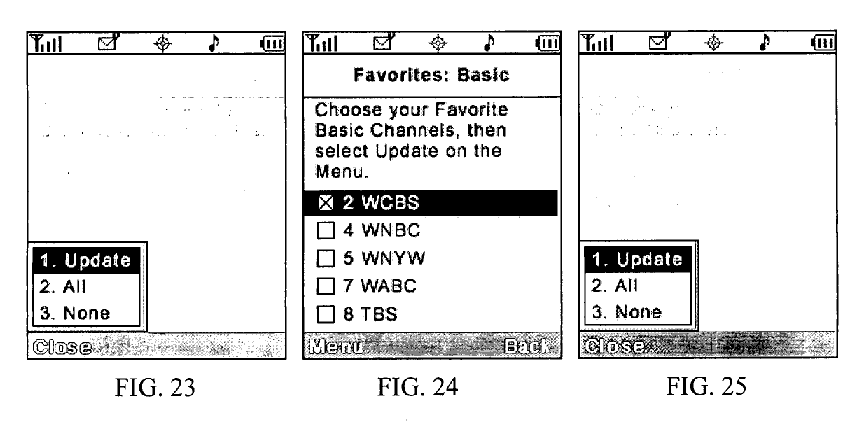

Similarly, to clear all the check boxes the user would highlight None in the pop-up menu, then click OK on the device keypad. This will remove any check marks next to channels. The user would select Menu again to open the pop-up menu, highlight Update and click OK on the keypad. (See FIG. 23).

While information is stored, a Please Wait message screen is displayed.

The Favorites Saved screen will then appear.

2.13 Favorites: Basic

If a user has specified that s/he receives Cable or Satellite service (see 2.4: Type of Service), one or more Favorites Channels screens may be displayed, depending upon how many channel levels are received as part of the user's subscription (e.g., Basic, Extended and Premium channels, etc.) Though the number of screens may vary, the functionality of each may be identical to that of the Favorites: Broadcast screen (see 2.12 above.)

If the user has specified only Basic service, only this screen would be displayed. (See FIG. 24).

The softkey navigational options available are Menu and Back. Back returns the user to the Congratulations screen (2.10).

If the user selects Menu, a pop-up menu appears. (See FIG. 25).

After the user has selected Favorite Basic Channels and Updated the list, a Please Wait message screen is displayed while information is stored.

If the user has specified additional Channel Levels, such as Extended, Premium and/or PPV Channels, the appropriate screen(s) would be displayed next as part of the Favorites set up process.

If the user has specified only Basic service, the Favorites Saved screen (2.20) will be displayed next.

2.14 Favorites: Extended

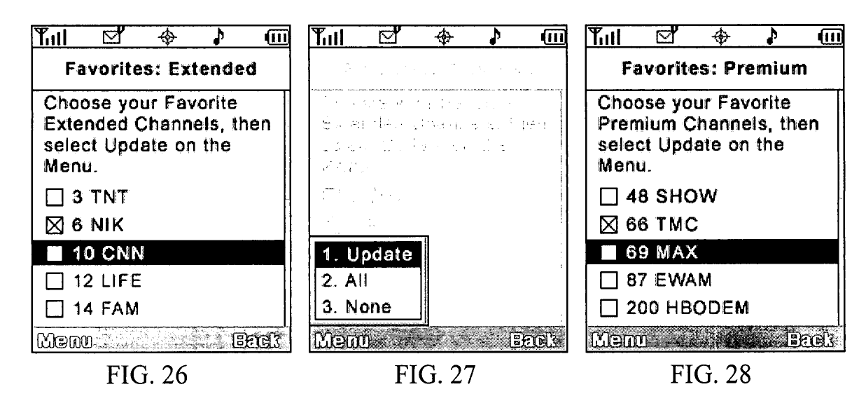

The Favorites: Extended set up screen appears if the user has specified that Extended Channels are included in the user's cable or satellite subscription (see 2.4: Type of Service). (See FIG. 26).

The functionality of this screen is identical to that of the Favorites: Broadcast and Favorites: Basic screens (see above).

The softkey navigational options available are Menu and Back. Back returns the user to the Favorites: Basic screen (2.13).

After the user has selected Favorite Extended Channels and Updated the list (see FIG. 27), a Please Wait message screen is displayed while information is stored.

If the user has specified additional Channel Levels, the appropriate screen(s) would be displayed next.

If the user has not specified additional Channel Levels, then the Favorites Saved screen (2.17) would be displayed.

2.15 Favorites: Premium

The Favorites: Premium set up screen appears if the user has specified that Premium Channels are included in the cable or satellite subscription (see 2.4: Type of Service). (See FIG. 28). For the purposes of this specification, Premium Channels are assumed to be those in the top Channel Level (e.g., HBO, Showtime, etc.)

The functionality of this screen is identical to that of the other Favorites set-up screens (see above).

The softkey navigational options available are Menu and Back. Back returns the user to the previous Favorites screen (Basic or Extended, depending on the Channel Levels specified by the user).

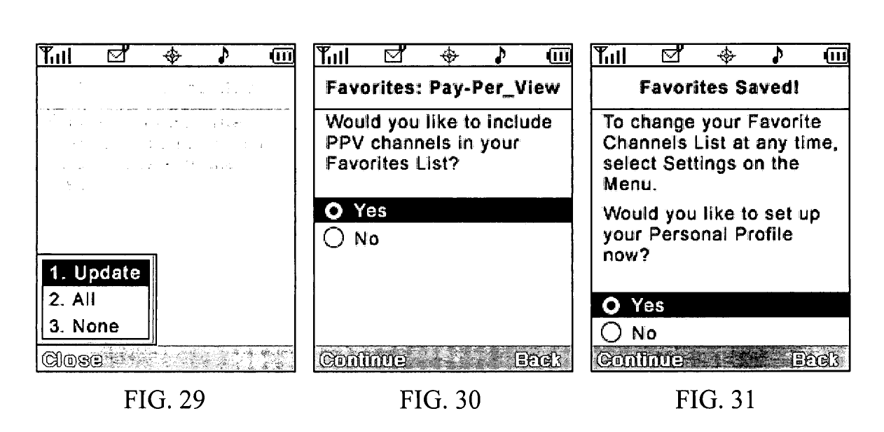

After the user has selected Favorite Premium Channels and Updated the list (see FIG. 29), a Please Wait message screen is displayed while information is stored.

If the user has specified that PPV channels should be included in the core Channel List, then the Favorites: Pay-Per-View screen (2.16) would be displayed next.

If the user has not included PPV Channels in the core Channel List, then the Favorites Saved screen (2.17) would be displayed.

2.16 Favorites: Pay-Per-View

The Favorites: Pay-Per-View set up screen appears if the user has specified that PPV Channels should be included in the core Channel List (see 2.8: PPV Channels). (See FIG. 30).

Other than Yes and No, the navigational options available to the user are Continue and Back. Back returns the user to the appropriate Favorites set up screen (see above.)

If the user chooses Yes and then selects Continue, the PPV Favorites information will be saved and the Registration process advances to the Favorites Saved screen (2.17). If the user chooses No and selects Continue, that information is stored and the process advances to the Favorites Saved screen.

A Please Wait message screen is displayed while information is stored.

2.17 Favorites Saved!

Once the user's Favorite channels information has been submitted and saved, a confirmation screen is displayed. (See FIG. 31).

On the same screen, a second message prompts the user to set up a Profile.

Other than Yes and No, the navigation options are Continue and Back. Back returns the user to the Favorites: Pay-Per-View screen (2.16).

Users who choose Yes and select Continue will proceed to the Profile set up screen.

If the user chooses No and selects Continue, the UGuide Home screen (1.3) will be displayed.

2.18 Your Profile

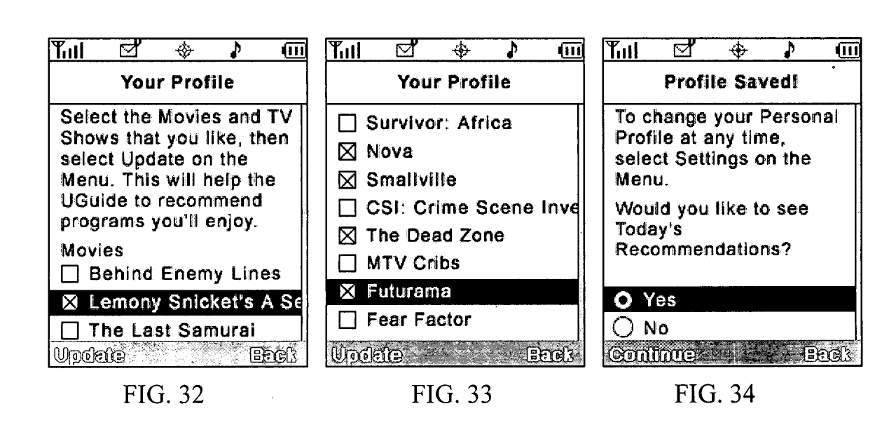

The Profile set up screen presents the user with a scrollable, selectable list of titles, including movies, episodic TV series and other programs. (See FIG. 32). By default, all boxes are unchecked.

The list contains selections from various genres (drama, comedy, action, etc.) Genre preferences provided by the user will form the initial basis of the personalized recommendations generated by the Gist Recommendation Engine. (Other examples of recommendation-generation methods (RGMs) include actor and director matches. Any and all such RGMs might be employed by the Recommendation Engine.)

The user can highlight any title in the list and click the OK key to select/deselect the highlighted title.

The softkey navigational options provided are Update and Back. Back returns the user to the Favorites Saved screen (2.17), or the Congratulations screen (2.10) depending upon the user's previous decisions.

The user may choose as many or as few of the titles as desired (See FIG. 33), then select Update to save the information in the Profile. Once the user has made selections and clicked Update, the Profile Saved screen (2.19) is displayed.

2.19 Profile Saved!

Once the user's Profile information has been submitted and saved, a confirmation screen is displayed. (See FIG. 34).

On the same screen, a second message prompts the user to view Recommendations.

Other than Yes and No, the navigation options are Continue and Back. Back returns the user to the Profile screen (2.18).

Users who choose Yes and select Continue will proceed to the Recommendations screen (3.1).

If the user chooses No and selects Continue, the UGuide Home screen (1.3) will be displayed.

### Example 3

### Recommended

3.1 Recommended

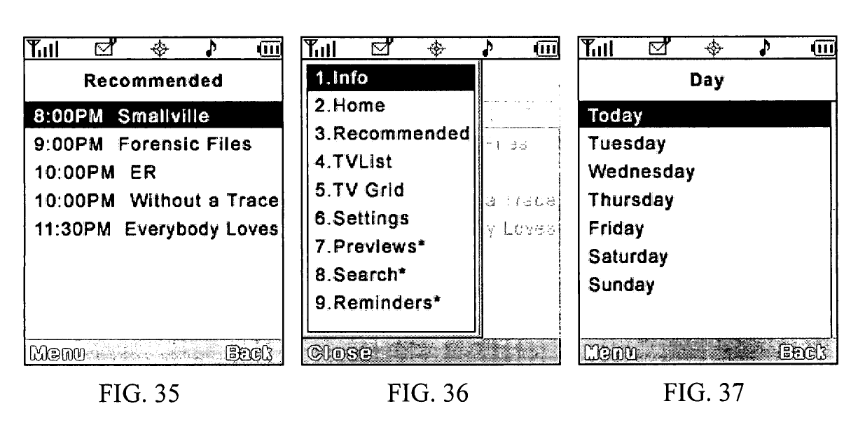

The recommendation engine preferably will generate and deliver several recommendations to the user every day (e.g., 5 Daily Recommendations). (See FIG. 35). These recommendations will be for programs scheduled to air within a 24 hour period (e.g., midnight to 11:59 PM) on any channels available to the user (determined by the user's TV Service Provider, Type of Service, Channel Levels, etc.)

The day's recommended programs are listed in chronological order. Each Recommended item is selectable. If the user highlights a recommended program and clicks OK on the mobile device keypad, the Program Description screen (6.1) will be displayed. Alternatively, the user can highlight a program and select Info from the pop-up Menu in order to see the desired Program Description. (See FIG. 36).

Softkey navigation on the Recommended screen is Menu and Back. Back brings the user to the Home screen (1.3). If the user selects Menu, a pop-up menu appears, containing the Info option in addition to the core navigation.

### Example 4

### TV List

4.1 TV List: Day

When the user selects TV List from the Menu or the Home screen, a scrollable list showing Today plus the next 6 days is displayed. (See FIG. 37). Each item is selectable. If the user highlights a Day (e.g., Wednesday) and clicks OK on the mobile device keypad, a Time screen will be displayed. Softkey navigation on the Day screen is Menu and Back. Back brings the user to the Home screen (1.3). If the user selects Menu, a pop-up menu will appear, containing either the View All Channels or View Favorite Channels option (if applicable) in addition to the core navigation.

4.2 TV List: Time

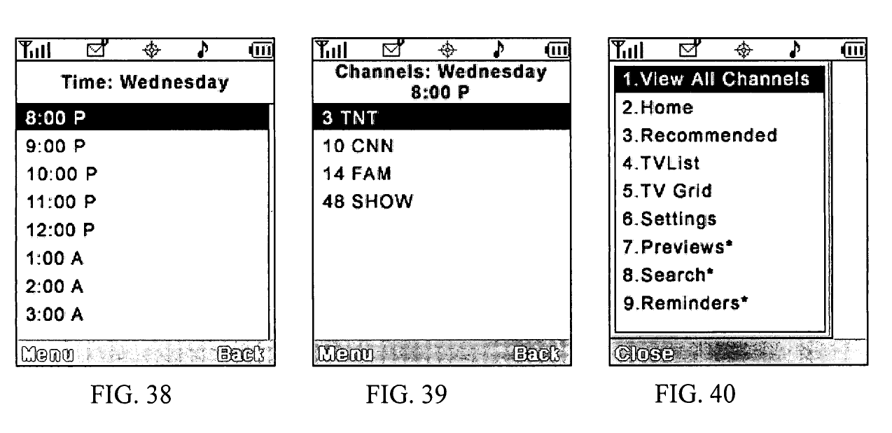

After the user has selected a Day on the Day screen (4.1), a Time screen is displayed. The Time screen is a scrollable list of the next 24 hours (See FIG. 38). Each item is selectable. If the user highlights a time (e.g., 8 PM) and clicks OK on the mobile device keypad, a Channels screen will be displayed.

Softkey navigation on the Time screen is Menu and Back. Back brings the user to the Day screen (4.1). If the user selects Menu, a pop-up menu will appear, containing either the View All Channels or View Favorite Channels option (if applicable) in addition to the core navigation.

4.3 TV List: Channels

This screen is a listing of the channels available in the user's channel lineup. (See FIG. 39). If the user has set up a Favorite Channels List, then Favorite Channels will be displayed by default.

Softkey navigation on the Channels screen is Menu and Back. Back brings the user to the Time screen (4.2). If the user selects Menu, a pop-up menu appears, containing either the View All Channels or View Favorite Channels option (if applicable) in addition to the core navigation.

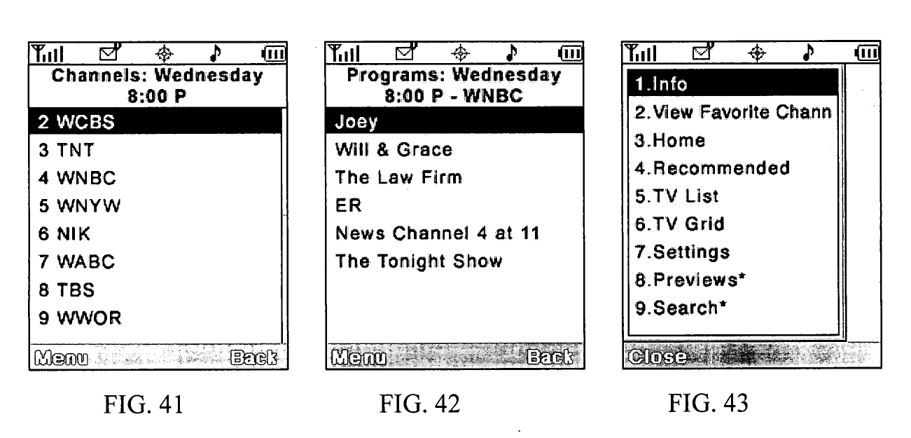

To switch to a list showing All Channels, the user can select View All Channels from the pop-up navigational Menu. (See FIG. 40). While navigating the TV List screens, the user can switch between viewing All Channels (see FIG. 41) or Favorite Channels at any point.

Each item on the scrollable Channel list is selectable. If the user highlights a channel (e.g., 4 WNBC) and clicks OK on the mobile device keypad, a Programs screen (4.3) will be displayed.

4.4 TV List: Programs

The Programs screen displays a scrollable list of titles. (See FIG. 42). The topmost position on the list is occupied by the program (e.g., “JOEY”) airing at the previously specified time (e.g., 8 PM) on the previously specified channel (e.g., 4 WNBC) on the previously specified day (Wednesday).

Depending upon the mobile device memory capacity and the amount of listings data available, the list of titles will include programs scheduled for broadcast during the 2-4 hour period following the specified time.

In our example, the Programs screen would display all programs airing on channel 4 WNBC between 8 PM and 12 AM.

To view details about any of the programs on the list, the user can highlight any one of the titles and click OK on the mobile device keypad, and the relevant Program Description screen (6.1) will be displayed. Alternatively, the user can highlight a program and select Info from the pop-up Menu in order to see the desired program details.

Softkey navigation on the Programs screen is Menu and Back. Back brings the user to the Channels screen (4.2). If the user selects Menu, a pop-up menu appears, containing the Info option in addition to View All Channels or View Favorite Channels (if applicable) and the core navigation. (See FIG. 43).

If the user selects View Favorite (All) Channels, the appropriate Channels screen (4.3) would be displayed.

### Example 5

### TV Grid

5.1 TV Grid (Favorite Channels)

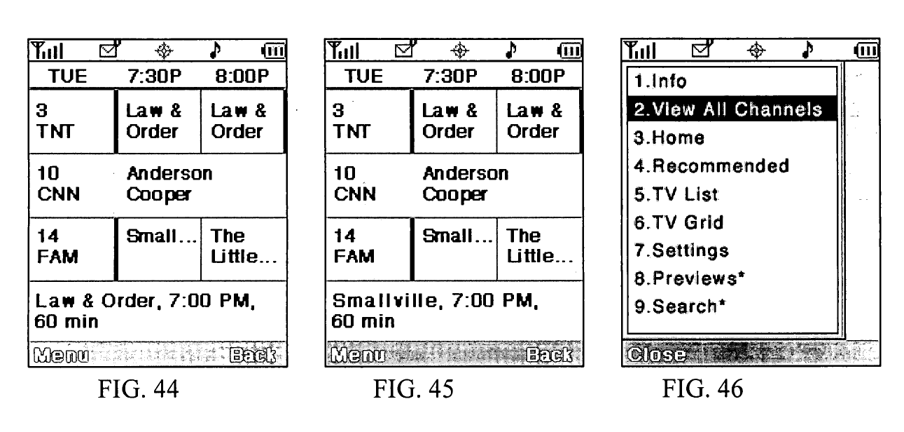

The TV Grid presents a scrollable listing of channels and scheduled programs. (See FIG. 44).

If the user selects TV Grid from the pop-up menu or on the Home screen, an EPG, showing available channels and scheduled programs for the current day and hour, is displayed. By default, the TV Grid displays the user's Favorite Channels (if the user has created a Favorite Channels List) and one hour of program information, starting from the current half-hour (e.g., if it is 4:19 PM, the grid will display the 4:00 to 4:30 PM and 4:30 to 5:00 PM time slots.) If the mobile device has sufficient available memory, up to four hours of listings data will be retrieved when the TV Grid is launched.

The TV Grid is divided into 3 vertical columns and 2-4 horizontal rows (dependent upon screen size and display capabilities of the mobile device.)

Each cell in a time slot column contains the title of the program scheduled to be broadcast on the corresponding channel during that half-hour period. Within a cell, the text of a program title may wrap and/or be truncated (e.g., The Little . . . ) if it is too long to fit. If a program spans or exceeds the entire one-hour time slot, the text may extend to the limit of the combined half-hour cells (e.g., ANDERSON COOPER.)

If program length exceeds the one-hour time slot, a graphic indicator would appear in the appropriate cell, signaling to the user that the program started earlier, continues into the next time slot or both (e.g., LAW & ORDER.)

5.2 TV Grid (Navigation)

At the bottom of the TV Grid screen, a minimal program description is displayed. As users navigate around the grid, the mini-description changes, providing information about the currently-highlighted program. In the example, “SMALLVILLE” is the highlighted program, and related information is displayed in the mini-program description area. (See FIG. 45). If the user were to move the cursor up, highlighting “ANDERSON COOPER”, then the mini-description would change, displaying “ANDERSON COOPER” information.

Directional keys on the mobile device keypad (up, down, left and right) are used to navigate through the grid. Users can scroll up or down to see more channels in the same time slot, or scroll to the right to see more time slots for the list of channels currently being viewed. Once the user has navigated “forward” to see one or more future time slots, it is possible to go “backward” only until the current time slot is displayed. For example, if it is now 7:30 PM, the user can scroll horizontally to the right in order to see what's on at 11:30 PM, but the user will not be able to scroll to the left to see what was on at 6 PM.

Key navigation is consistent with that of the TV List. To view details about any of the programs in the Grid, the user can highlight any one of the titles, click OK on the mobile device keypad, and the relevant Program Description screen (6.1) will be displayed. Alternatively, the user can highlight a program and select Info from the pop-up Menu in order to see the desired program details.

Softkey navigation on the TV Grid screen is Menu and Back. Back brings the user to the Home screen. If the user selects Menu, a pop-up menu appears, containing the Info option in addition to View All Channels or View Favorite Channels (if applicable) and the core navigation. (See FIG. 46).

### Example 6

### Program Description

6.1 Program Description Screen

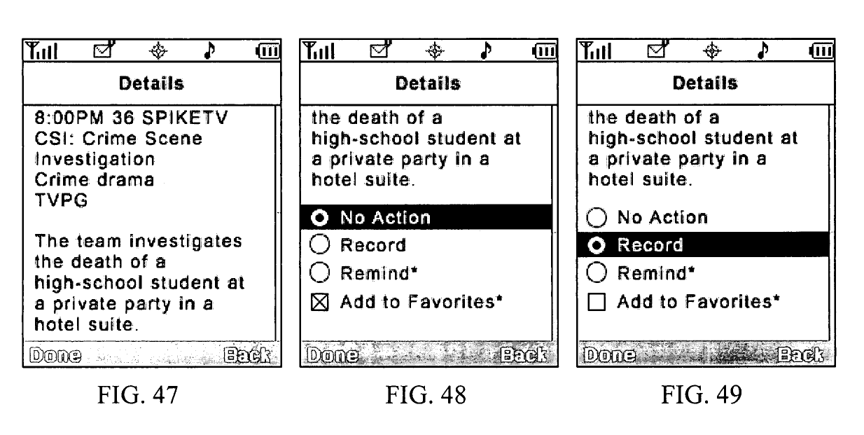

The extent of the program information is dependent upon the listings data. However, the program description preferably includes start time, channel (number and station ID), program title, genre, rating, and synopsis or other descriptive text. (See FIG. 47).

The navigation on the screen includes: No Action; Record (if digital recording device option has been activated); Remind; and Add to Favorites. (See FIG. 48).

The first three choices are all mutually exclusive (‘radio’ buttons): the user preferably must choose one option to the exclusion of the other two. However, the user may choose Add to Favorites in addition to any one of the other choices.

Softkey navigation includes Back and Done. Back returns the user to the previously viewed screen (Recommended, the TV List: Programs screen or the TV Grid.)

If the user chooses No Action and then selects Done, s/he returns to the previously viewed screen (similar to selecting the Back key.)

If the user chooses Record and then selects Done, the UGuide application will generate a “Record Request” for that program (7.1), initiating a remote recording.

### Example 7

### Remote Digital Recording

7.1 Record Request

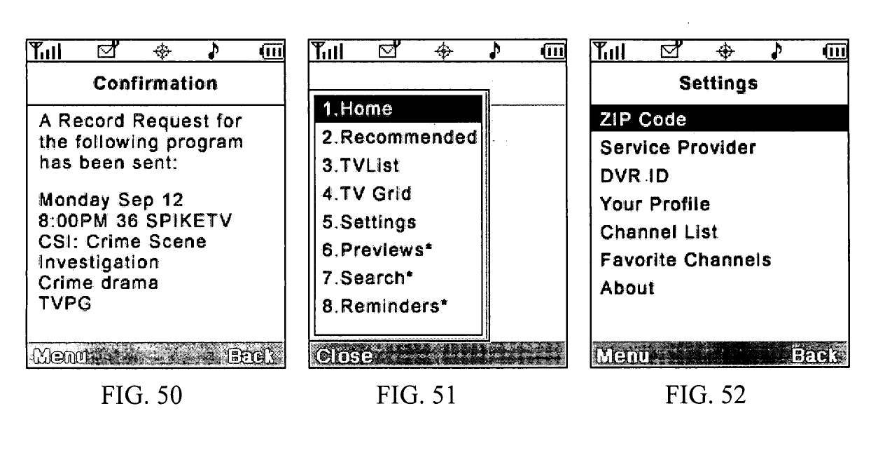

If the user chooses the Record option on the program Details screen (see FIG. 49) and selects the Done softkey, the UGuide application will generate a “Record Request” for that program. At that point, a Confirmation screen (7.2) would be displayed, informing the user that the Record Request for the desired program has been sent. (See FIG. 50).

7.2 Confirmation Screen

Options available to the user on the Confirmation screen are the Menu and Back softkeys.

Back will return the user to the screen viewed prior to the program description, whether it be the Recommended screen, the TV List: Programs screen or the specific TV Grid screen that includes the selected program.

If the user selects the Menu softkey, a pop-up menu appears, providing the user with the core navigation. (See FIG. 51).

The Record Request will be sent to the UGuide server, and will be stored.

### Example 8

### Settings

8.1 Settings Screen

The Settings screen presents the user with a menu of selectable items, reflecting the information provided by the user during the Registration process. (See FIG. 52).

The user can choose to edit any of the items on the Settings list, in no particular order. However, some of the Settings are interrelated and/or dependent on other settings, and editing one will automatically necessitate editing others. For example, if the user changes the Zip Code, it preferably will be necessary to update the TV Service Provider information.

Softkey navigation options available to the user are Back and Menu. Back will take the user to the Home screen (1.3). If the user highlights a menu choice and selects Go from the pop-up Menu, the specified screen will load. Alternatively, the user could highlight a choice and click the OK button on the mobile device.

8.2 Edit Zip Code

The USPS zip code provided during Registration is displayed in a text entry field. (See FIG. 53). The user can edit the existing zip code or enter a different one. The text field only accepts numbers and is limited to 5 digits.

Navigational options available to the user are Done and Back.

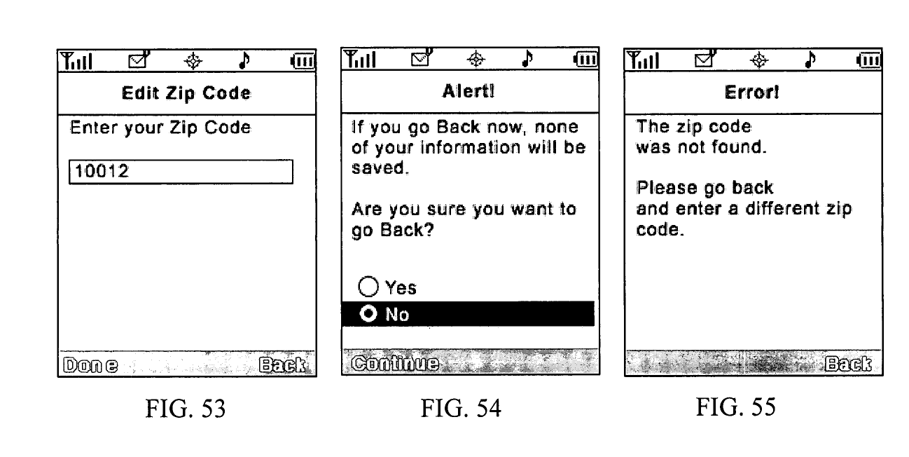

If the user chooses to go Back from the Edit Zip Code screen, none of the information entered thus far will be saved. This holds true even if the user has proceeded through several of the subsequent Settings screens (e.g., Edit TV Provider, Edit Channel Lineup), and selected the Back button until returning to the Edit Zip Code screen. If the user is on the Edit Zip Code screen and selects Back, an alert prompt will appear. (See FIG. 54).

Yes brings the user to the Settings screen (8.1); No brings them back to the Edit Zip Code screen, with the zip code they have previously entered displayed in the text entry field.

If the user edits the 5-digit zip code (or enters a different one) and selects Done, a zip code validation process is initiated. The submitted zip code is compared to zip codes in the database that are associated with television service providers across the United States. While this validation is performed, a Please Wait message screen is displayed.

If the submitted zip code is valid, the user automatically proceeds to the Edit TV Service screen (8.3).

If the zip code is invalid, an Error message is displayed, prompting the user to enter a different zip code. (See FIG. 55).

8.3 Edit TV Service

Because of the interrelated nature of the service provider components, the user preferably will not be able to edit the Service Provider settings out of sequence.

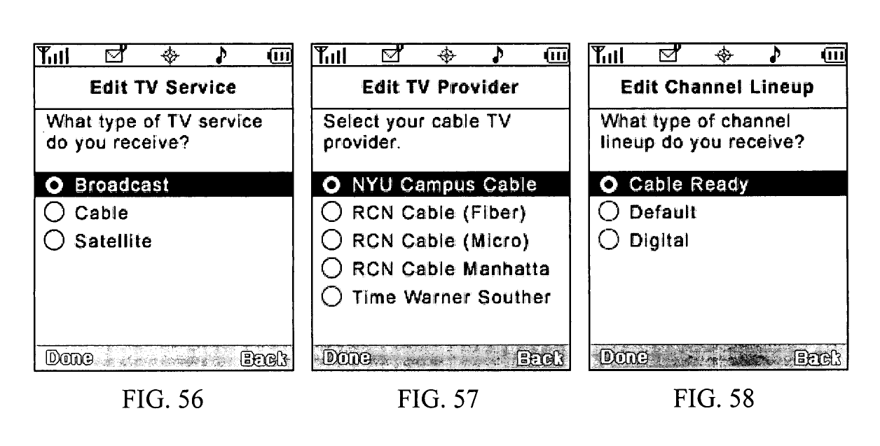

To update any and all of the TV service information, the user would select Service Provider on the Settings screen. The Edit TV Service screen would then be displayed. The choices presented on the Edit TV Service screens would correspond to the user's zip code, saved during Registration. (See FIG. 56).

If the user has edited the zip code (see above), the Edit TV Service screen could be displayed automatically, presenting information relating to the new zip code.

The user is prompted to specify the type of television service received. The user preferably may choose only one of the options.

Other than the TV service type selection, the softkey navigational options available to the user are Done and Back. Back returns the user either to the Edit Zip Code screen (8.2) or to the Settings screen (8.1), depending upon how the user navigated to the Edit TV Service screen.

If the user chooses Broadcast and then selects Done, the editing process for Service Provider is complete, and the Settings screen is displayed.

If the user chooses Cable or Satellite and then selects Done, the Edit TV Provider screen (8.4) is displayed.

8.4 Edit TV Provider

The user is prompted to select the appropriate cable or satellite TV service provider. (See FIG. 57). The list presented displays the operators (e.g. TIME WARNER CABLE) that provide the specified service type (e.g. cable TV) in the user's zip code. Preferably, users may choose only one provider.

Other than the service provider selections, the navigational options available to the user are Done and Back. Back returns the user to the Edit TV Service screen (8.3).

If a satellite subscriber chooses a TV provider and then selects Done, the Edit Channel Levels screen (8.6) is displayed.

If a cable subscriber chooses a TV provider and then selects Done, the Edit Channel Lineup screen (8.5) is displayed.

8.5 Edit Channel Lineup

The user is prompted to specify the type of channel lineup received (e.g. Analog or Digital). (See FIG. 58). Choices presented to the user reflect the lineups offered by the cable TV service provider (see above.)

Other than the Channel Lineup selections, the navigational options available to the user are Done and Back. Back returns the user to the Edit TV Provider screen (8.4).

If the user chooses a Channel Lineup and then selects Done, the Edit Channel Levels screen (8.6) is displayed.

8.6 Edit Channel Levels

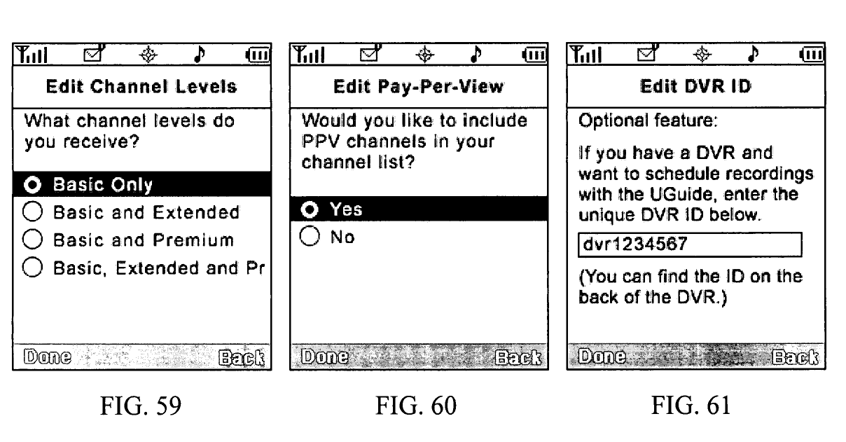

The user is prompted to specify the Channel Levels received with the user's cable or satellite subscription. (See FIG. 59).

Other than the Channel Levels selections, the navigational options available to the user are Done and Back. Back returns cable subscribers to the Edit Channel Lineup screen (8.5), but returns satellite subscribers to the Edit TV Provider screen (8.4).

If the user chooses a Channel Level and then selects Done, the Edit PPV Channels screen (8.7) is displayed.

8.7 Edit Pay-Per-View Channels

The user is offered the option of including Pay-Per-View channels in the core Channel List. (See FIG. 60).

Other than Yes and No, the navigational options available to the user are Done and Back. Back returns the user to the Edit Channel Levels screen (8.6).

If the user chooses Yes or No, and then selects Done, the updated Service Provider information (including PPV Channels) is saved and the Settings screen (8.1) is displayed.

8.8 Edit Digital Recording Device ID

If the user has previously saved a Digital Recording Device ID during the Registration, the ID is displayed in the text entry field. The ID can be edited or replaced by a new ID. (See FIG. 61).

If no ID had been saved, the text entry field will be blank.

Other than the text entry field, the navigational options available to the user are Done and Back. Back returns the user to the Settings screen (8.1).

If the user does not edit the Digital Recording Device ID and then selects Done, the Settings screen is displayed.

If the user makes any edits, and then selects Done, the changes will be saved and the Settings screen will be displayed.

8.9 Edit Your Profile

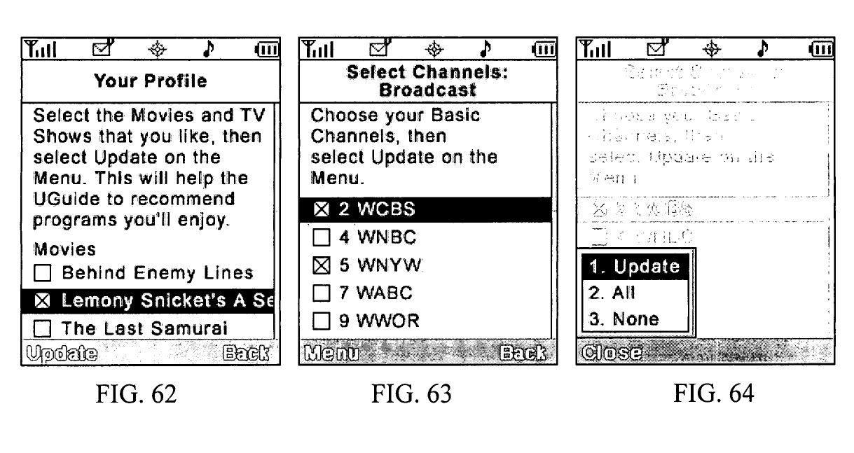

If the user wishes to edit the Profile, s/he can highlight any title in the list and click the OK key to select/deselect the highlighted title. (See FIG. 62).

The softkey navigational options provided are Update and Back. Back returns the user to the Settings screen (8.1).

The user may choose as many or as few of the titles as desired, then select Update to save the information in the Profile. Once the user has made selections and clicked Update, the Settings screen is displayed.

8.10 Edit Channel List: Broadcast

The Channel List screen(s) enable the user to confirm that the channels listed in the UGuide correspond to the channels received on the user's TV at home.

If a user has specified that s/he receives only Broadcast channels, instead of Cable or Satellite service, only one Channel List screen will be displayed, because there is only one Broadcast channel level. (See FIG. 63).

Functionality is identical to the Favorite Channels set-up screens (2.12-2.15). By default, all channels are selected. If a channel appearing on the List is not actually available on the user's system, the user has the option to deselect the channel. Channels that are deselected will not appear in the TV List or the TV Grid screens, regardless of whether the user is viewing All Channels or Favorite Channels.

The user can highlight any channel in a list and click the OK key to select/deselect the highlighted channel.

In addition, the navigational options provided are Menu and Back. Back returns the user to the previously viewed screen.

If the user selects Menu, a pop-up menu appears. On this pop-up, the user can highlight Update, All or None. (See FIG. 64). If no action is desired, the pop-up menu can be closed and the list will remain unchanged.

After checking and/or unchecking desired channels, the user would select Menu again to open the pop-up menu, highlight Update and click OK on the keypad.

While information is stored, a Please Wait message screen is displayed.

8.11 Edit Channel List: Basic

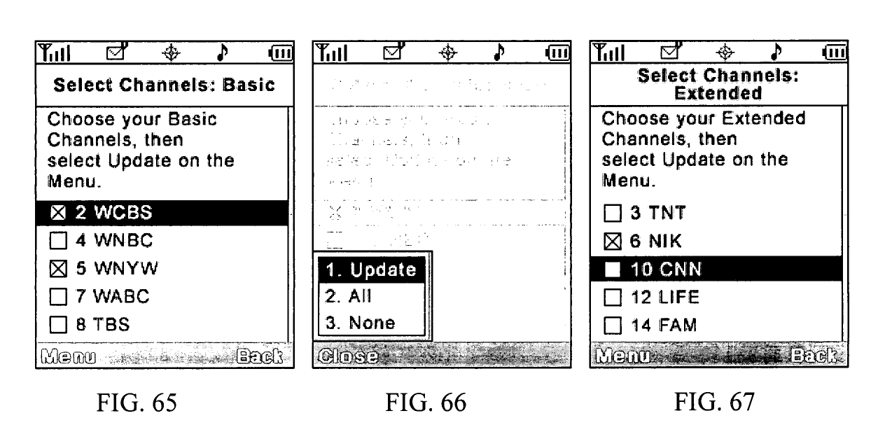

If a user has specified that s/he receives Cable or Satellite service, one or more Channel List screens may be displayed, depending upon how many channel levels are received as part of the user's subscription (e.g., Basic, Extended and Premium channels, etc.) Though the number of screens may vary, the functionality of each will be identical. (See FIG. 65).

The user can highlight any channel in a list and click the OK key to select/deselect the highlighted channel. Navigation options provided are Menu and Back. Back returns the user to the previously viewed screen; Menu provides a pop-up menu that enables the user to select All or None.

After checking and/or unchecking desired channels, the user would select Menu again, highlight Update (see FIG. 66). and click OK on the keypad. While information is stored, a Please Wait message screen is displayed.

8.12 Edit Channel List: Extended

If a user has specified that s/he receives Extended Channels as part of Cable or Satellite service, this screen will be displayed. (See FIG. 67).

Functionality is identical to the Edit Channel List: Basic screen (8.11).

8.13 Edit Channel List: Premium

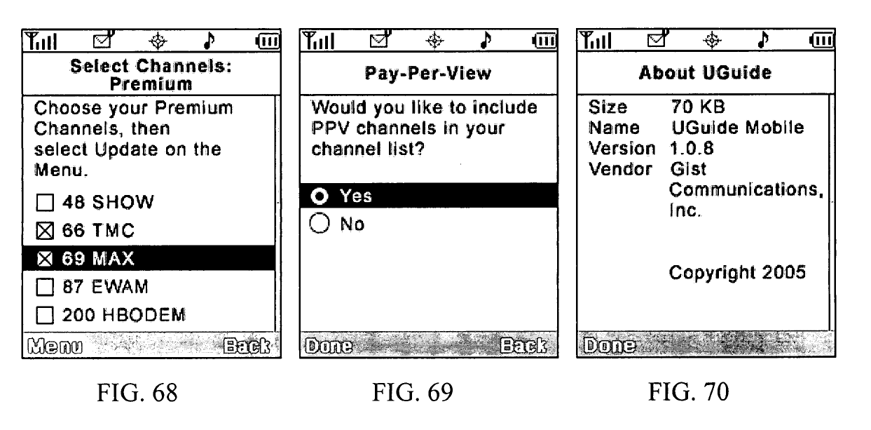

If a user has specified that s/he receives Premium Channels as part of Cable or Satellite service, this screen will be displayed. (See FIG. 68).

Functionality is identical to the Edit Channel List: Basic screen (8.11) and the Edit Channel List: Extended screen (8.12).

8.14 Edit Channel List: PPV

The user can edit the previously set option of including Pay-Per-View channels in the core Channel List. (See FIG. 69).

Other than Yes and No, the navigational options available to the user are Done and Back. Back returns the user to the previously viewed screen.

If the user chooses Yes or No, and then selects Done, the updated Channel List information (including PPV Channels) is saved and the Settings screen (8.1) is displayed.

8.15 About UGuide

This screen displays basic information about the UGuide application. (See FIG. 70).

Preferably, the only navigational option available to the user is Done, which returns the user to the Settings screen (8.1).

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all written publications, all U.S. and foreign patents and patent applications, and all published statutes and standards, are specifically and entirely incorporated by reference. It is intended that the specification and examples be considered exemplary only with the true scope and spirit of the invention indicated by the following claims.

1. A system for scheduling recordings on a handheld wireless device comprising:
a handheld wireless device comprising an application configured to allow selection of program content to be recorded on a recording device,
a server system configured to receive instructions for recording a program from a handheld wireless device and configured to transmit instructions to a recording device, and
a recording device configured to receive instructions from the server system and configured to record program content selected on the handheld wireless device.

2. The system of claim 1, wherein the program content is selected from the group consisting of broadcast television content, broadcast radio content, satellite radio content, satellite television content.

3. The system of claim 1, wherein the program content is content transmitted on the Internet.

4. The system of claim 1, wherein the program content is in digital format.

5. The system of claim 1, wherein the server transmits TV listing data to the handheld wireless device.

6. The system of claim 1, wherein the server transmits a list of recommended program content to the handheld device.

7. The system of claim 6, wherein a third-party provider is able to transmit selections to the server for the list of recommended program content.

8. The system of claim 6, wherein the list of recommended program content is selected based on preference criteria that are specific to a user of the handheld wireless device.

9. The system of claim 6, wherein the list of recommended program content is transmitted to the handheld wireless device at specified intervals.

10. The system of claim 1, wherein the recording device is a digital recording device.

11. The system of claim 1, wherein the recording device is a digital video recorder.

12. The system of claim 1, wherein the recording device receives instructions from the server over the Internet.

13. The system of claim 1, wherein the recording device has a unique Device ID and the server identifies the recording device utilizing the Device ID.

14. The system of claim 1, wherein the recording device receives instructions from the server over a broadcast stream.

15. The system of claim 14, wherein the broadcast stream is a program stream of a cable or satellite or cable television system.

16. The system of claim 1, wherein the recording device transmits messages to the server.

17. The system of claim 16, wherein the messages comprise recording conflict alerts or scheduling conformations.

18. The system of claim 16, wherein the server transmits the messages to the handheld wireless device.

19. A method of scheduling recordings on a handheld wireless device comprising:
receiving instructions from a handheld wireless device over a cellular network, and
transmitting instructions to a recording device to record program content based on the instructions from the handheld wireless device.

20. The method of claim 19, wherein the program content is selected from the group consisting of broadcast television content, broadcast radio content, satellite radio content, satellite television content and content transmitted on the Internet.

21. The method of claim 19, wherein the program content is in digital format.

22. The method of claim 19, further comprising transmitting TV listing data to the handheld wireless device.

23. The method of claim 19, further comprising transmitting a list of recommended program content to the handheld device.

24. The method of claim 23, further comprising receiving selections from a third-party provider for the list of recommended program content.

25. The method of claim 23, wherein the list of recommended program content is selected based on preference criteria that are specific to a user of the handheld wireless device.

26. The method of claim 23, wherein the list of recommended program content is transmitted to the handheld wireless device at specified intervals.

27. The method of claim 19, wherein the recording device is a digital recording device.

28. The method of claim 19, wherein the recording device is a digital video recorder.

29. The method of claim 19, wherein the instructions to the recording device are transmitted over the Internet.

30. The method of claim 19, wherein the recording device has a unique Device ID and the server identifies the recording device utilizing the Device ID.

31. The method of claim 19, wherein the instructions to the recording device are transmitted over a broadcast stream.

32. The method of claim 31, wherein the broadcast stream is a program stream of a cable or satellite or cable television system.

33. The method of claim 19, further comprising receiving messages from the recording device.

34. The method of claim 33, wherein the messages comprise recording conflict alerts or scheduling conformations.

35. The method of claim 33, further comprising transmitting the messages from the recording device to the handheld wireless device.

36. A handheld wireless device configured to schedule recordings on a recording device comprising:
a handheld wireless device comprising an application configured to allow selection of program content to be recorded on a recording device.

37. The device of claim 36, wherein the program content is selected from the group consisting of broadcast television content, broadcast radio content, satellite radio content, satellite television content.

38. The device of claim 36, wherein the program content is content transmitted on the Internet.

39. The device of claim 36, wherein the program content is in digital format.

40. The device of claim 36, wherein the handheld wireless device receives TV listing data.

41. The device of claim 36, wherein the handheld wireless device receives a list of recommended program content.

42. The device of claim 41, wherein the list of recommended program content is selected based on preference criteria that are specific to a user of the handheld wireless device.

43. The device of claim 41, wherein the handheld wireless device receives the list of recommended program content at specified intervals.

44. The device of claim 36, wherein the recording device is a digital recording device.

45. The device of claim 36, wherein the recording device is a digital video recorder.

46. The device of claim 36, wherein the handheld wireless device receives messages from the recording device.

47. The device of claim 46, wherein the messages comprise recording conflict alerts or scheduling confirmations.
